(19) United States
(12) Patent Application Publication
(10) Pub. No.: US 2009/0006145 A1
(43) Pub. Date: Jan. 1, 2009

(54) Booking Advertising Campaigns

(75) Inventors: Jagpreet S. Duggal, San Francisco, CA (US); Yan-David Erlich, San Francisco, CA (US); Robert D. Gardner, Irvine, CA (US); Alexandr Y. Smolyanov, Rancho Santa Margarita, CA (US); Bozhena Bidyuk, Westminster, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/769,549

(22) Filed: Jun. 27, 2007

(51) Int. Cl. G06Q 10/00

(52) U.S. Cl. 705/6

(57) ABSTRACT

Various aspects can be implemented for automated booking of advertising campaigns based on reach and frequency goals In general, one aspect can be a method that includes receiving campaign criteria including target reach and frequency for an advertising campaign. The method also includes allocating advertising spots based on the campaign criteria, and generating projected campaign reach and frequency based, at least in part, on the allocated advertising spots. The method further includes determining whether projected campaign reach and frequency sufficiently match target reach and frequency, and dynamically adjusting the allocation of advertising spots when the projected campaign reach and frequency do not sufficiently match the target reach and frequency. Other implementations of this aspect include corresponding systems, apparatus, and computer program products.

### TECHNICAL FIELD

This disclosure generally relates to booking advertising campaigns based on advertising campaign criteria, such as reach and frequency goals.

### BACKGROUND

Advertisements can be included in various forms of broadcast media. For example, radio can be a powerful broadcast medium for advertisers to achieve their goals for a given advertising campaign. Additionally, radio advertising can increase online brand awareness, and be a cost effective way to reach a targeted audience. For example, an advertiser can target consumers with a specific lifestyle and demographics by selecting the station types, locations, and dayparts. Advertisers can book advertising campaigns with multiple broadcasters through an ad intermediary. Advertisers can specify criteria that the intermediary can use to book advertising spots for the advertising campaigns.

### SUMMARY

This specification describes various aspects relating to automated booking of advertising campaigns based on advertising campaign criteria, which can include, for example, reach and frequency goals. Automated booking can automatically determine if a campaign's projected reach and frequency sufficiently match the reach and frequency goals of the advertising campaign and, depending on the answer, dynamically adjust advertising spot allocation to better achieve the campaign goals.

In general, one aspect can be a method that includes receiving campaign criteria including target reach and frequency for an advertising campaign. The method also includes allocating advertising spots based on the campaign criteria, and generating projected campaign reach and frequency based, at least in part, on the allocated advertising spots. The method further includes determining whether projected campaign reach and frequency sufficiently match target reach and frequency, and dynamically adjusting the allocation of advertising spots when the projected campaign reach and frequency do not sufficiently match the target reach and frequency. Other implementations of this aspect include corresponding systems, apparatus, and computer program products.

Another general aspect can be a system that includes an advertiser-facing module configured to interface with an advertiser and to obtain campaign criteria comprising target reach and frequency for an advertising campaign. The system also includes a metrics calculation module configured to calculate projected campaign reach and frequency. The system further includes means for dynamically allocating advertising spots in the advertising campaign to cause the calculated reach and frequency to better match the target reach and frequency. The system additionally includes a broadcaster-facing module configured to interface with one or more broadcasters that broadcast one or more advertisements during the allocated advertising spots.

These and other general aspects can optionally include one or more of the following specific aspects. The method can include obtaining available advertising spots from broadcasters that meet the campaign criteria. The method can also include booking the advertising campaign when the projected campaign reach and frequency sufficiently match the target reach and frequency. The receiving of campaign criteria can include receiving a specified minimum and a specified maximum number of advertising spots to be allocated. The minimum and maximum number of advertising spots can be specified per broadcasting group within a predetermined period of time. For example, the broadcasting group can be any aggregation of broadcasters, including, e.g., a network of radio stations or just a single radio station. The predetermined period of time can be, e.g., a duration of a week, two-weeks, or a month.

The dynamic allocation of advertising spots can include generating a new minimum and a new maximum number of advertising spots to be allocated, and obtaining newly available advertising spots to fill the advertising campaign based on the new minimum and the new maximum number of advertising spots. The allocation of advertising spots can include obtaining available advertising spots from broadcasters, which are then allocated in accordance with the campaign criteria including a predetermined campaign metric. The predetermined campaign metric can include campaign metrics such as efficiency or target cost per thousand impressions (CPM).

The allocation of advertising spots can also include determining whether a first broadcaster's available advertising spots are less than the specified minimum number of advertising spots. The allocation of advertising spots can further include determining whether the first broadcaster is a strategic broadcaster when the first broadcaster's available advertising spots are less than the specified minimum number of advertising spots, and booking all the available advertising spots from the first broadcaster when the broadcaster is a strategic broadcaster.

The allocation of advertising spots can include calculating a number of advertising spots needed from the first broadcaster when the first broadcaster's available advertising spots are not less than the specified minimum number of advertising spots. The allocation of advertising spots can also include determining whether the number of advertising spots needed from the first broadcaster is greater than the specified maximum number of advertising spots.

The allocation of advertising spots can further include booking the number of advertising spots needed from the first broadcaster when the number of advertising spots needed from the first broadcaster is not greater than the specified maximum number of advertising spots, and booking the specified maximum number of advertising spots from the first broadcaster when the number of advertising spots needed from the first broadcaster is greater than the specified maximum number of advertising spots. The broadcasters can include terrestrial radio stations, satellite radio stations, television stations, podcasters, cellular broadcasters, or Internet broadcasters. The advertising campaign criteria can be specified by an advertiser or a customer service representative via a user interface.

Particular aspects can be implemented to realize one or more of the following potential advantages. In addition to specifying a target number of impressions, an advertiser can specify its desired target reach and frequency for an advertising campaign. Furthermore, advertising campaigns can be booked automatically based on reach and frequency goals specified, e.g., by the advertiser or a customer service representative.

In one example, minimum and maximum number of advertising spots to be allocated per broadcaster group within a predetermined period of time (e.g., a week) can be configurable in a campaign and can be used as a measure of reach and frequency information. Based on the allocated advertising spots, the automated system can calculate the projected campaign reach and frequency for a given advertising campaign without relying on a third-party information source (e.g., ACT One software's calculation on reach and frequency). Additionally, the automated booking can automatically determine if the projected campaign reach and frequency sufficiently match the reach and frequency goals of the advertising campaign and, depending on the answer, dynamically adjust advertising spot allocation to better achieve the campaign goals.

The general and specific aspects can be implemented using a system, method, or a computer program, or any combination of systems, methods, and computer programs. The details of one or more implementations are set forth in the accompanying drawings and the description below. Other features, aspects, and advantages will be apparent from the description, the drawings, and the claims.

### DESCRIPTION OF DRAWINGS

These and other aspects will now be described in detail with reference to the following drawings.

FIG. 1 is a conceptual diagram of an advertising campaign showing relationships between various advertising components.

FIG. 2 is a schematic diagram of a system for booking an advertising campaign.

FIG. 3 is a flow chart illustrating a process for dynamically booking an advertising campaign based on campaign criteria.

FIG. 4 is a flow chart illustrating a process for allocating advertising spots to broadcasters based on campaign criteria.

FIG. 5 shows an example user interface for booking advertising spots from various broadcasters.

FIG. 6A is a flow chart illustrating a process for dynamically adjusting available advertising spots based on campaign criteria.

FIG. 6B is a diagram showing how available advertising spots from broadcasters can be dynamically adjusted based on the campaign criteria.

FIG. 7 is a block diagram of a computing device and system used to implement the advertising campaign booking system.

Like reference symbols in the various drawings indicate like elements.

### DETAILED DESCRIPTION

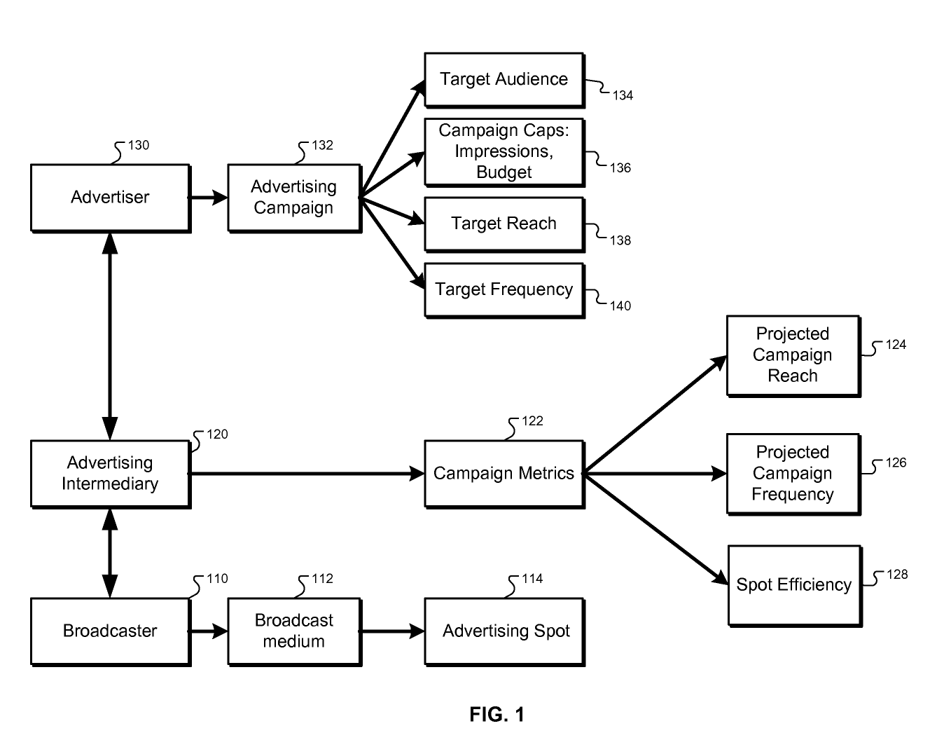

FIG. 1 is a conceptual diagram of an advertising campaign showing relationships between various ad components. The diagram shows a broadcaster 110, which can include, e.g., a terrestrial radio station, a satellite radio station, a television station, a podcaster, a cellular broadcaster, or an Internet broadcaster. The broadcaster 110 can deliver broadcast content to the audience via broadcast medium 112, which can include, e.g., radio, television, or the Internet, or any digital broadcast medium. Additionally, various advertising spots, such as advertising spot 114, can be included as part of the broadcast content. The advertising spots are time slots when ads can play during a broadcast. For example, advertising spot 114 can be a 30-second time slot of the broadcast content.

The conceptual diagram of FIG. 1 also shows an advertising intermediary 120, which can include, e.g., Google Adwords for Audio. The advertising intermediary 120 can interface with and communicatively couple to the broadcaster 110 to manage available advertising spots for advertising campaigns. For example, the advertising intermediary 120 can provide a price rate (i.e., spot price or rate card price) associated with advertising spot 114. The rate card price can be a function of the number of estimated audience, which can vary based on the type of broadcaster, broadcasting market (e.g., Los Angeles vs. San Diego), and broadcasting daypart (e.g., morning commute vs. evening commute).

For example, in radio advertising a commonly used measure of estimated listeners is a metric called average quarter hour (AQH) persons. The gross AQH can be defined as the average number of persons (ages 12 and above) listening to a broadcast for at least five minutes of a given 15-minute period. This information on gross AQH can be provided by third-party ratings companies, such as Arbitron.

Various campaign metrics 122 can be calculated by the advertising intermediary 120. Campaign metrics 122 can include, for example, a campaign reach 124, a campaign frequency 126, a spot efficiency 128, and a cost per mille (CPM) metric, or cost per thousand impressions. An impression can be defined as when an ad is played (e.g., audibly or visually) so that an audience can experience or perceive (e.g., hear or see) the ad. For example, given the rate card price and a gross AQH number for the spot, a gross CPM can be calculated as: gross CPM=(rate card price/gross AQH)*1000.

Reach and frequency are campaign metrics and can be used to measure the effectiveness of an advertising campaign. In radio advertising for example, “reach” estimates the number of unique listeners who hear the ad at least once during a given schedule; and “frequency” can estimate the average number of times each listener hears the ad during a given time period. The product of reach and frequency is approximately equal to the number of impressions; i.e., impressions˜reach*frequency. Additionally, a gross reach per advertising spot can be associated with the gross AQH, which is described above. Since an advertising spot has a frequency of 1 (because it is presumed that the ad can be played once per advertising spot), for an advertising spot, gross reach can approximately equal gross AQH or impressions.

For a successful advertising campaign, advertisers need to be concerned not just by how much media is consumed, as a whole, but how many people are consuming it and how often. Thus, reach and frequency information can be important for an effective advertising campaign because it answers the questions of “How many potential customers are you talking to?” and “How often do you ask them for their business?” Further, when allocating advertising spots for a campaign, it can be important to maximize reach of the campaign while keeping frequency in a preferred range. For example, it is generally known in the advertising industry that people only “hear” or “see” the ad and take action if they are actually interested in the type of service advertised. By maximizing reach, the advertiser can maximize the number of potential customers who perceive the ad.

The reach of the campaign, however, cannot simply be calculated by adding up the reach for all the allocated advertising spots. This is because there can be an overlap between the demographics of two advertising spots. For example, suppose an advertising campaign has two advertising spots allocated to it. Advertising spot #1, which is scheduled to be broadcast at 9 a.m. on Monday, has a gross AQH of 10,000 listeners; and advertising spot #2, which is scheduled to be broadcast at 10 a.m. on Tuesday, has a gross AQH of 8,000 listeners. The total reach for the advertising campaign (i.e. campaign reach) is likely a number between 10,000 and 18,000 unique listeners. The campaign reach can be closer to 10,000 unique listeners if most of the listeners overlap between the two advertising spots; on the other hand, the campaign reach can be closer to 18,000 unique listeners if very few of the listeners overlaps between the two advertising spots. The degree of overlap can depend on whether the two advertising spots are broadcast by the same broadcaster, in the same market, in the same daypart, or in the same format/category.

Unlike reach, the frequency of ad play is not always maximized because it can depend on the product being advertised (e.g., a pack of chewing gum vs. an automobile) and campaign objective (e.g., branding campaign vs. direct response campaign). For example, if the person hears the ad only once, he or she may forget too easily or may hear the ad at the wrong time and not be prepared to act. Hearing the ad 2-3 times considerably increases the chance that people will be able to remember it later and, subsequently, take action. However, when people hear the same ad too many times, they can become annoyed and stop paying attention.

Thus, the preferred frequency of ad play can vary depending on the campaign objective. For example, in most cases an advertiser may prefer to have a preferred frequency of 3. However, in some cases, e.g., branding campaigns, a higher frequency value in the range of 3-7 might be desirable. In some instances, advertisers may choose to disregard frequency constraints all together. For example, direct response advertisers, who are trying to get their listeners to dial a number and request service in response to their ads, may prefer very high frequency. Since listeners are not likely to remember the advertised phone number later, advertisers in this category maximize the chances of someone calling in by increasing the frequency of the ad.

In an advertising campaign, the average campaign frequency (i.e., the average number of ad play per listener) can be calculated based on the number of advertising spots allocated. For example, suppose that the weekday morning drive (6 a.m.-10 a.m.) spots for a radio station KROQ have a gross AQH of 10000 listeners; and that the weekday afternoon drive (3 p.m.-7 p.m.) spots for a radio station KISS also has a gross AQH of 10000 listeners. Assume that there is no overlap in demographics between the two radio stations. If an advertising campaign books 10 of the weekday morning drive spots on KROQ and 20 of the 5 p.m. weekday afternoon drive spots on KISS, then the average campaign frequency is 15.

The conceptual diagram of FIG. 1 further shows an advertiser 130 who is interested in increasing its revenue by launching an advertising campaign 132. The advertiser 130 can define a marketing objective for the advertising campaign 132. For example, the objectives can be to increase awareness of the advertiser or the advertiser's product. Additionally, the marketing objectives can be to drive sales for a specific promotion, holiday, or event. Thus, the advertiser 130 can specify various criteria for the advertising campaign 132 in order to achieve the marketing objective.

As an example, the advertiser 130 can specify a target audience 134 for the advertising campaign 132. For example, suppose that the advertising campaign 132 is a radio advertising campaign; specifying the target audience 134 can include targeting by location, gender, age, station the audience listens to, and drive time/time of day the audience might be listening. Additionally, the advertiser 130 can interface with and communicatively couple to the advertising intermediary 120. For example, based on the demographics information of the target audience 134 for the advertising campaign 132, a target AQH can be calculated by the advertising intermediary 120 using the gross AQH number described above.

For instance, suppose that the gross AQH for an advertising spot is 10,000 listeners, which means that on average 10,000 listeners (ages 12 and above) listen to the broadcast in a 15-minute time period. Further, suppose that the target audience is only male listeners who are between the ages of 24 and 40. Based on this information and the gross AQH number, a target AQH number, can be, e.g., 2000 listeners that fit the demographics profile. Additionally, a spot efficiency 128 for the targeted demographics profile can be calculated as: spot efficiency=target AQH/gross AQH. Thus, the spot efficiency 128 measures the percentage of listeners for an advertising spot that meets the targeted demographics profile.

Given rate card price and a target AQH number for the spot, a target CPM for an advertising spot can be calculated as: target CPM=(rate card price/target AQH)*1000. Since the target AQH is a percentage (depending on the targeted demographic profile) of the gross AQH, the target CPM is always greater than or equal to the gross CPM for an advertising spot. For example, if the rate card price for an advertising spot is $10 and the gross AQH is 10,000 listeners, while the target AQH is 2000 listeners, then the gross CPM is $1 and the target CPM is $5 for the advertising spot.

In addition to the target audience 134, the advertiser 130 can also specify campaign caps 136 for the advertising campaign 132. Campaign caps 136 can include, e.g., number of impressions, daily budget, weekly budget, and total campaign budget. The advertiser 130 can further specify a target reach 138 for the advertising campaign 104. As noted above, reach can represent the number of unique persons who perceived (e.g., heard or saw) the ad. For example, the advertiser 130 can specify a target reach 138 of 10,000 people for an advertising campaign. Additionally, the advertiser 130 can specify a target frequency 140 for the advertising campaign 104. As described above, frequency can represent the average number of times that a person has perceived the ad. As will be described in more detail below, the number of advertising spots allocated per broadcaster and per week can be used to determine both the reach and the frequency for an advertising campaign.

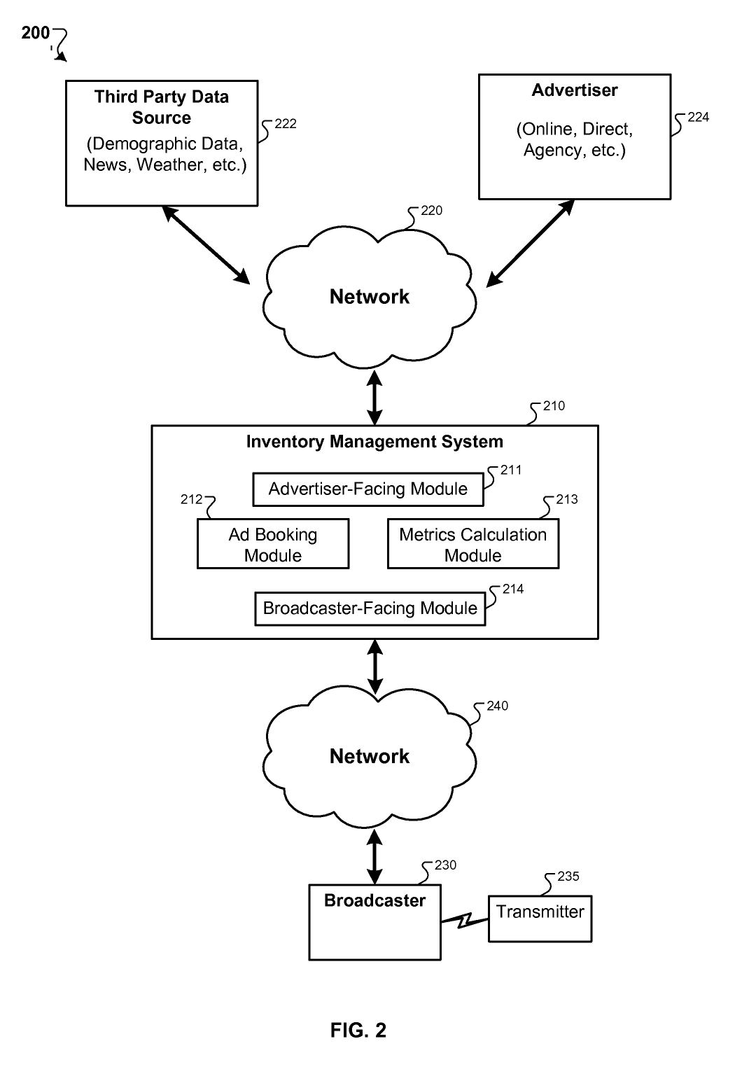

FIG. 2 is a schematic diagram of a system 200 for booking an advertising campaign based, e.g., on target reach and frequency. The methods, processes, engines, apparatus, computer program products, systems and the like discussed below can be applicable to audio advertising environment and other communication environments including broadcast television, cable television, satellite television, Internet communication systems (including Internet radio and Internet TV), and other communication environments.

Ads can be inventoried and categorized for system 200 in several ways, e.g., by keyword, price, vendor, last played, and the like. In some implementations, the broadcasters can use the ad inventory information and other data to schedule current ads, and reschedule new ads that may be more suitable (e.g., suitable in terms of content, price, or other criteria) in a particular time slot. For example, a broadcaster can sell a last-minute ad at a higher price (e.g., higher CPM) than other previously received ads.

As shown in FIG. 2, system 200 includes an ad inventory management system (IMS) 210, which can include an advertiser-facing module 211, an ad booking module 212, a metric calculation module 213, and a broadcaster-facing module 214. The advertiser-facing module 211 can interface with and communicatively couple to third-party data source 222 and advertiser 224 via a network 220. In this example, the network 220 is the Internet. In other implementations, the network 220 can include any network, such as a local area network, metropolitan area network, wide area network, a wired or wireless network, a private network, or a virtual private network.

The ad booking module 212 can be used by the IMS 210 to, e.g., book an advertising campaign for the advertiser 224. Additionally, ad booking module 212 can allocate advertising spots that most closely match with the advertiser's campaign criteria (e.g., target reach and frequency) for an advertising campaign. The metrics calculation module 213 can be used by the IMS to, e.g., calculate the spot efficiency for an advertising spot and campaign reach and frequency for an advertising campaign. The broadcaster-facing module 214 can interface via network 240 with broadcaster 230, which can be, e.g., a radio station. In one implementation, network 240 can be a similar network as network 220. The broadcaster 230 can deliver broadcast content to the audience via transmitter 235.

The third-party data source 222 can include any database, data mart, or other data source that provides data of interest to the advertiser 224 relevant to the scheduling of advertisements. For example, third-party data can be Arbitron ratings and demographic breakdowns for each station in a broadcast network. Further, such third-party data can be of use to an advertiser 224 in deciding what amount it would be willing to pay to run an advertising campaign on a given station. In addition, third-party data can be the weather forecast, current weather conditions, or news events such as stock prices, sports scores, data from a syndicated data feed such as an RSS feed, or any other data relevant to a advertiser's desire to play an ad.

The advertiser 224 can include, e.g., online advertiser, direct sales advertiser, and advertising agency. The advertiser 224 can access the IMS 210 via a connection to the Internet 220. The connection can include, e.g., a TCP/IP protocol using a conventional dial-up connection over a modem, or a dedicated connection that provides constant access (e.g., a cable modem or a DSL connection). The IMS 210 can have a unique HTTP address, a unique FTP address, or any other addressing scheme that allows advertiser 224 to identify the IMS 210. In one implementation, advertiser 224 can have an account with the IMS 210 and be charged a fee for use of the IMS 210. In another implementation, advertiser 224 can access the IMS 210 free of charge.

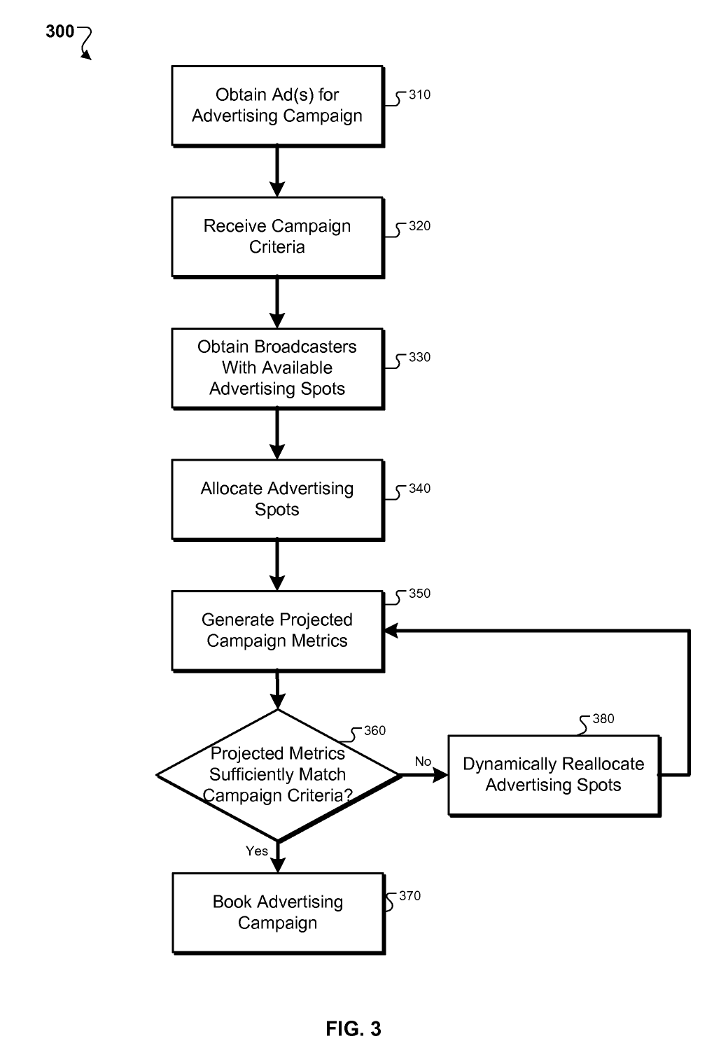

FIG. 3 is a flow chart illustrating a process 300 for dynamically booking an advertising campaign based on campaign criteria. At 310, process 300 obtains one or more ads for an advertising campaign. Depending on the length and the objective of the advertising campaign, the advertiser may want to broadcast more than one ad during the campaign. The ads can be produced by the advertiser directly or can be produced by a radio production professional. At 320, process 300 receives advertising campaign information/criteria from, e.g., the advertiser or a customer service representative of the advertising intermediary. For example, as noted above, the advertiser can specify a target audience, target reach and frequency, a cap for number of impressions, daily budget, weekly budget, or total budget for the advertising campaign.

Additionally, the advertising campaign criteria can include a minimum and a maximum number of advertising spots to be allocated. The minimum and maximum number of advertising spots can be specified per broadcasting group within a predetermined period of time. For example, the broadcasting group can be any aggregation of broadcasters, including, e.g., a network of radio stations or just a single radio station. The predetermined period of time can be, e.g., a duration of a week, two weeks, or a month.

In one implementation, the minimum and maximum number of advertising spots can be specified per station/broadcaster per week, as an average over the weeks within each “flight” of the advertising campaign. A flight of the advertising campaign can be defined as a “sub-campaign” or a pre-determined time period within an advertising campaign for which specific campaign goals can be set. For example, a campaign can have multiple flights and each flight can include one or more dayparts and/or broadcasters. Additionally, each flight can use a different ad to achieve the specific goal for that flight.

These average minimum and maximum number of advertising spots to be allocated can be specified by the advertiser or a customer representative. Additionally, these average minimum and maximum number of advertising spots to be allocated can be specified by process 300 as a default value; for example, a default minimum of 10 spots per broadcaster per week and a default maximum of 90 spots per broadcaster per week. As will be discussed in further detail below, the specified average minimum and maximum number of advertising spots to be allocated can be used as screening criteria for allocating advertising spots to broadcasters.

Furthermore, the advertising campaign information can include a strategic broadcaster list, which can be used as a flexible option for ignoring the specified average minimum and maximum number of advertising spots. For example, suppose three broadcasters are specified as strategic broadcasters (i.e., included in the strategic broadcaster list for the advertiser), process 300 can ignore the average minimum and maximum number of advertising spots and book all the available advertising spots from these three strategic broadcasters.

Process 300, at 330, obtains broadcasters with available advertising spots that can satisfy the campaign criteria, e.g., specified by the advertiser. For example, suppose that the advertiser specified a target demographics of male between 25-55 years old for the advertising spots, the obtained broadcasters can be those broadcasters that have available advertising spots with gross AQH satisfying the target demographics. Once the broadcasters with available advertising spots have been obtained, at 340, process 300 allocates advertising spots to broadcasters based on campaign criteria.

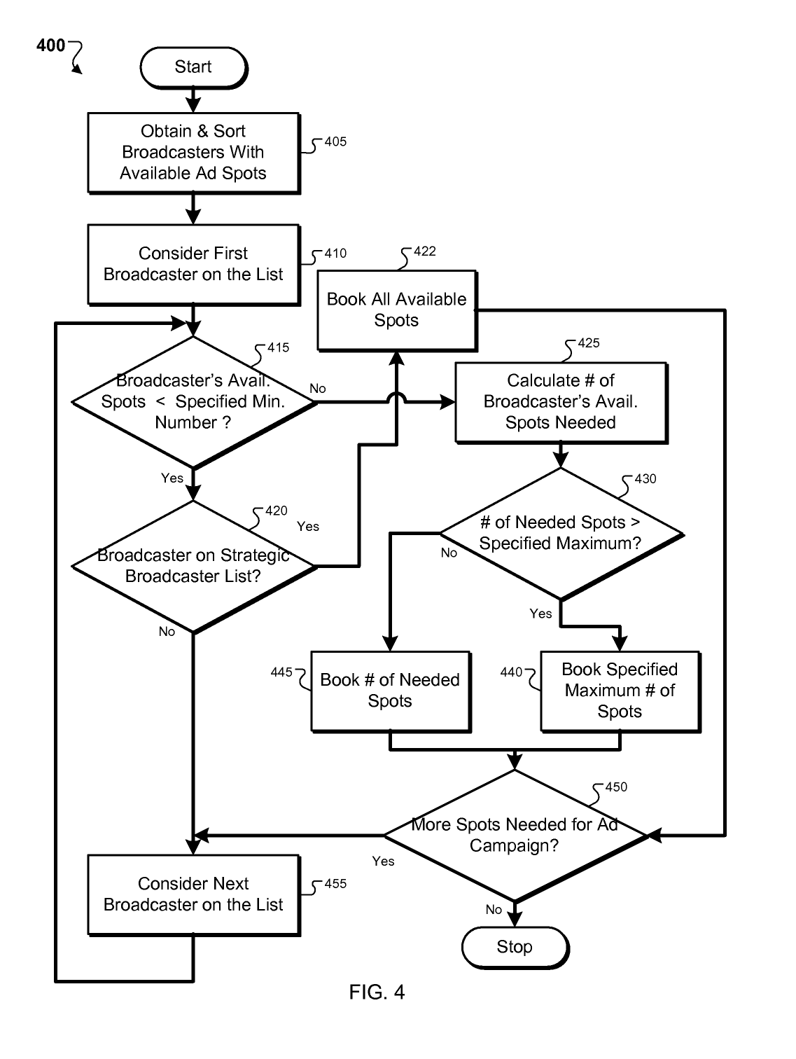

As will be discussed in more detail below in FIG. 4, in allocating advertising spots, process 300 can first eliminate those broadcasters that have fewer available advertising spots than the specified minimum advertising spots. Additionally, process 300 can determine whether any of those broadcasters to be eliminated is on the strategic broadcaster list. If the broadcaster is on the strategic broadcaster list, process 300 can proceed to allocate available advertising spots to such broadcaster, regardless of whether such broadcaster meets the specified minimum advertising spots. In this manner, process 300 can allocate advertising spots to broadcasters that can satisfy at least the minimum number of spots, while preserving the flexibility to allocate advertising spots to strategic broadcasters with less available advertising spots than the minimum number of spots.

After advertising spots have been allocated for the advertising campaign, process 300, at 350, generates projected campaign metrics, which can include, e.g., projected reach and frequency for the advertising campaign. For example, both projected reach and frequency for an advertising campaign can be calculated based on the allocated advertising spots. As described above, “reach” for an advertising campaign can vary depending on the overlap of demographics for the allocated advertising spots. Process 300 can use demographics information, e.g., provided by a third-party data source such as Arbitron, to generate a campaign reach for the advertising campaign. At 360, process 300 determines whether the projected campaign metrics sufficiently match the campaign criteria.

In one implementation, a tolerance can be specified, e.g. by the advertiser, for the target reach and frequency. For example, an advertiser may specify a target reach of 100,000 listeners ±10%. In this manner, if the projected campaign reach and frequency match the target reach and frequency within the specified tolerance (e.g., 10%), then process 300 can determine that the metrics sufficiently match the campaign criteria. In another implementation, process 300 can automatically specify a default tolerance (e.g., 5%) when a tolerance was not specified in the advertising campaign. If the projected campaign metrics sufficiently match the campaign criteria, at 370, process 300 can proceed to book the advertising campaign using the allocated advertising spots.

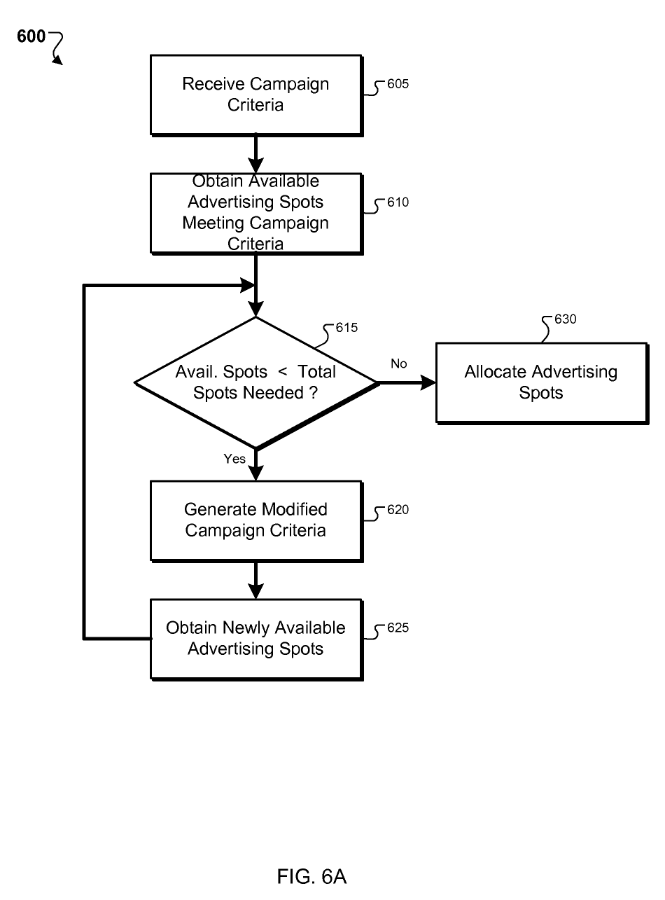

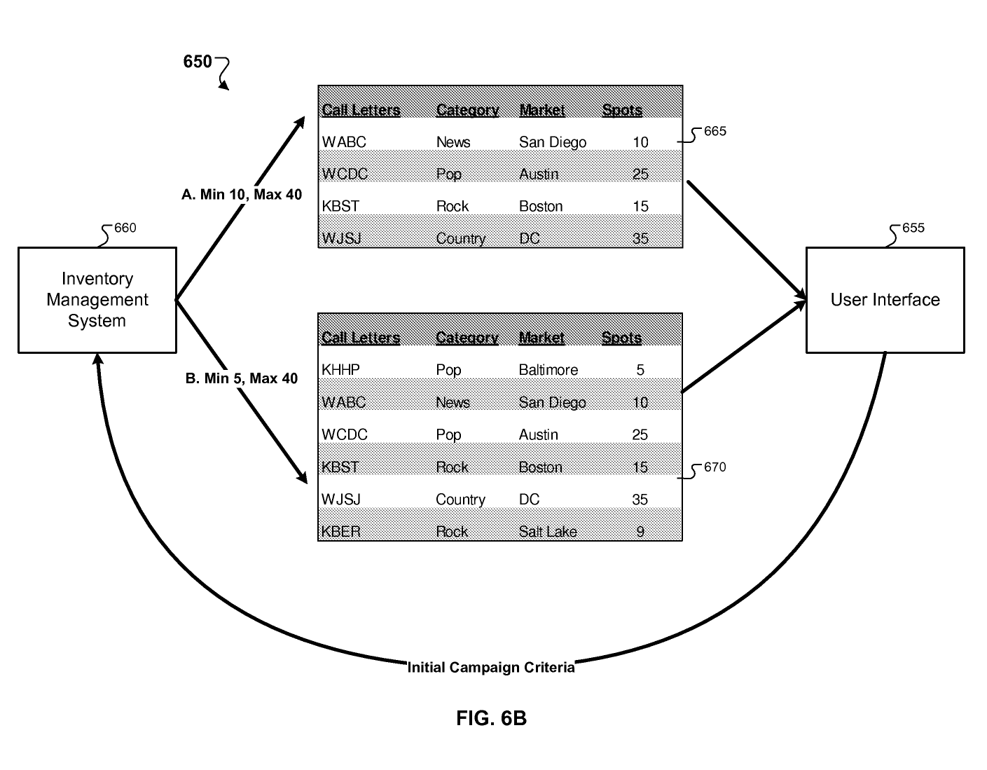

On the other hand, if the campaign metrics do not sufficiently match the campaign criteria, at 380, process 300 can dynamically reallocate advertising spots to generate a new set of projected campaign metrics, at 350. For example, process 300 can automatically generate a new minimum number and a new maximum number of advertising spots per broadcaster per week to be allocated. In this manner, process 300 can automatically determine if the campaign metrics match the campaign criteria of the advertising campaign, and dynamically adjust advertising spot allocation to better achieve the campaign goals. Further details on how the advertising spot allocation can be dynamically adjusted are discussed below in reference to FIG. 6. Once the advertising campaign is booked at 370, the one or more ads can be broadcast during the allocated advertising spots.

FIG. 4 is a flow chart illustrating a process 400 for allocating advertising spots to broadcasters based on campaign criteria, which can include, e.g., the specified minimum and maximum number of spots per broadcaster group within a predetermined time period. At 405, process 400 obtains broadcasters with available advertising spots and sorts them in a list, based on, e.g., spot efficiency. As noted above, the spot efficiency can be used to measure the percentage of audience for a given advertising spot that meets the specified target demographics profile for an advertising campaign. At 410, process 400 considers the first broadcaster on the sorted list of broadcasters. Process 400, at 415, determines whether the broadcaster's available advertising spots are less than the specified minimum advertising spots, which can, e.g., be specified by the advertiser or a customer service representative, or a default value specified by process 400.

If the broadcaster has available advertising spots that meet the specified minimum advertising spots for the advertising campaign, at 425, process 400 calculates the number of broadcaster's available spots needed for the advertising campaign. As noted above, campaign criteria such as target audience and number of impressions can be specified in an advertising campaign. Based on the campaign criteria, a total number of advertising spots needed for the advertising campaign can be determined. Thus, the number of each broadcaster's available spots needed for the advertising campaign will be less than the total number of advertising spots and can vary depending on how many advertising spots have already been booked for the campaign.

At 430, process 400 determines whether the number of advertising spots needed from the broadcaster is greater than the specified maximum advertising spots, which can, e.g., be specified by the advertiser or a customer service representative, or a default value specified by process 400. If the number is greater than the specified maximum, at 440, process 400 proceeds to book only the specified maximum number of advertising spots from the broadcaster. However, if the number of advertising spots needed from the broadcaster does not exceed the specified maximum, at 445, process 400 books the number of advertising spots needed from the broadcaster to the advertising campaign.

On the other hand, if the broadcaster has available advertising spots that are less than the specified minimum advertising spots for the advertising campaign, at 420, process 400 determines whether the broadcaster is on the strategic broadcaster list. If the broadcaster is on the strategic broadcaster list, at 422, process 400 books all the available advertising spots from the strategic broadcaster, despite the fact that there were not enough available advertising spots to meet the specified minimum advertising spots for the advertising campaign. At 450, process 400 determines whether more advertising spots need to be booked for the advertising campaign. If so, at 455, process 400 considers the next broadcaster on the list of broadcasters sorted at 405. However, process 400 stops when no more advertising spots need to be booked for the advertising campaign.

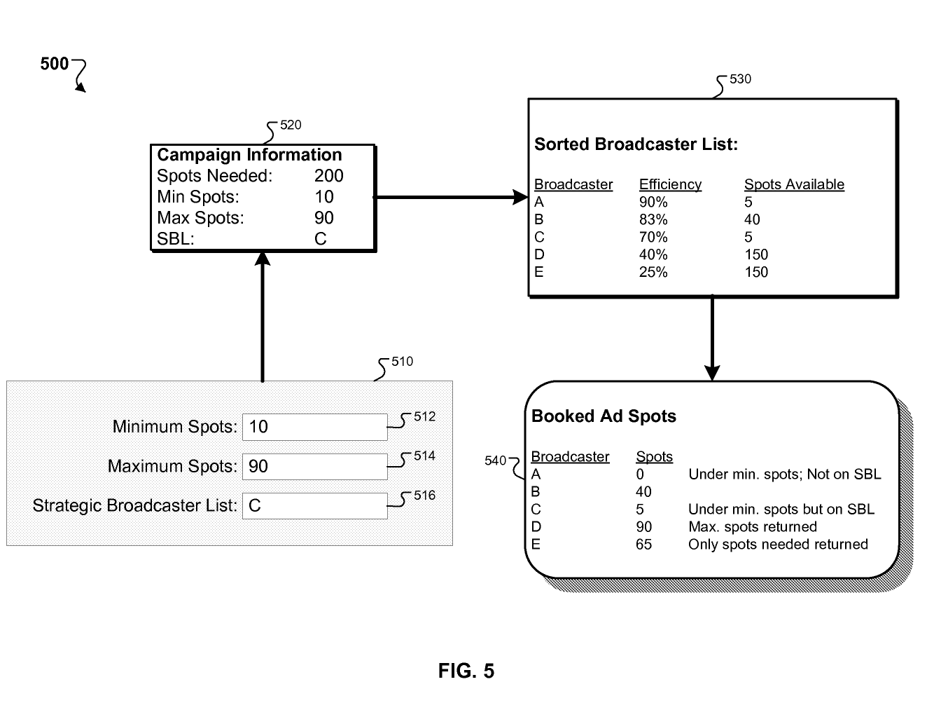

The process of allocating advertising spots to broadcasters based on the specified minimum and maximum number of allocated advertising spots for an advertising campaign can further be described using an illustrative example. FIG. 5 shows an example user interface 500 for booking advertising spots. As shown in FIG. 5, various display boxes can be presented in the user interface 500. Initially an advertiser or a customer service representative can specify the minimum and maximum number of advertising spots for an advertising campaign via a text entry box 510. Alternatively, as noted above, the booking system can automatically specify a default value for the minimum and maximum number of advertising spots.

For example, in the input box 512 the minimum spots to be allocated per broadcaster per week has been specified as 10; and the maximum spots to be allocated per broadcaster per week has been specified as 90 in the input box 514. Further, only one station (e.g., station C) has been specified as a strategic broadcaster on the strategic broadcaster list (SBL) in the input box 516. Additionally, other advertising campaign information (not shown) such as target reach and frequency, and budget cap can be specified through the text entry box 510.

After the advertising campaign information has been obtained from text entry box 510, display box 520 presents, e.g., a summary of the advertising campaign information. For example, box 520 can display that the advertising campaign needs 200 advertising spots, assuming each advertising spots has an equal AQH. Box 520 can also display that the specified minimum advertising spots is 10 and maximum advertising spots is 90. Additionally, box 520 can display that station C has been specified as a strategic broadcaster on the strategic broadcaster list. Using the information presented in display box 520, the automated booking system can obtain a list of broadcasters with available advertising spots and sort the broadcasters based on, e.g., efficiency.

In the example shown in box 530, the broadcasters are ranked in order of efficiency for an advertising campaign. As noted above, efficiency measures what percentage of listeners meets the target demographics profile specified by the advertising campaign. In another implementation, the broadcasters can be ranked by other metrics, such as a target CPM. Display box 530 shows that broadcaster A has an efficiency of 90% and 5 available advertising spots. Broadcaster B has an efficiency of 83% and 40 available advertising spots. Broadcaster C has an efficiency of 70% and 5 available advertising spots. Broadcaster D has an efficiency of 40% and 150 available advertising spots; and broadcaster E has an efficiency of 25% and also 150 available advertising spots.

After the broadcasters have been sorted or ranked, the automated booking system can then book advertising spots for the advertising campaign. For example, display box 540 shows how the available advertising spots from each broadcaster can be booked. Broadcaster A is first considered by the automated booking system; however, none of the available advertising spots from broadcaster A can be booked because broadcaster A only has 5 available spots, which is less than the specified minimum spots of 10. Additionally, since broadcaster A is not on the strategic broadcaster list, the specified minimum number does not get to be ignored.

Next, broadcaster B is considered by the automated system, and all 40 of the available advertising spots from broadcaster B can be booked for the advertising campaign. This is because the available spots from broadcaster B is greater than the specified minimum and less than the specified maximum, as shown in display box 520. Broadcaster C is then considered by the automated booking system, and unlike broadcaster A, all 5 available spots from broadcaster C can be booked for the advertising campaign. This is because broadcaster C is on the strategic broadcaster list and the specified minimum spot number of 10 can be ignored for a strategic broadcaster.

So far, 45 of the required 200 spots are booked from broadcasters B and C. The automated booking system still needs to book another 155 spots for the advertising campaign. Therefore, broadcaster D is considered by the automated booking system, and 90 of the 150 available spots can be booked for the advertising campaign. This is because only the specified maximum number of spots (90 in this example) can be booked for a given broadcaster. Next, the automated system considers broadcaster E, and allocates 65 of the 150 available spots to the advertising campaign. This is because after allocating 90 spots to broadcaster D, only 65 more spots are needed for the advertising campaign.

In this manner, the automated booking system can book advertising spots from broadcasters where, as a general rule, the available number of advertising spots meet the specified minimum number of spots per station per week, as an average over the weeks within each flight (but not across flights). Further, the automated booking system will not allocate more than the specified maximum number of spots per broadcaster per week on any broadcaster, as an average over the weeks within each flight (but not across flights). Additionally, the automated booking system can allocate spots on the broadcasters in the strategic broadcaster list where the specified minimum/maximum can be disregarded and any spots that a strategic broadcaster has available can be booked, irrespective of spot-per-week caps.

FIG. 6A is a flow chart illustrating a process 600 for dynamically adjusting available advertising spots based on campaign criteria, e.g., specified minimum and maximum number of advertising spots. Process 600 will be described in reference to FIG. 6B, which is a diagram showing how available advertising spots from broadcasters can be dynamically adjusted based on the campaign criteria. At 605, process 600 receives advertising campaign criteria for the advertising campaign, which can include, e.g., target reach and frequency and the specified minimum and maximum number of spots to be allocated per broadcaster per week.

As noted above, the minimum and maximum number of spots to be allocated per broadcaster per week can be specified by the advertiser, the customer service representative, or as a default value specified by the booking system. Further, the booked advertising spots can be used to calculate the reach and frequency for the advertising campaign. As shown in FIG. 6B, user interface 655 can be used to obtain the campaign criteria for the advertising campaign.

At 610, process 600 obtains available advertising spots from broadcasters meeting the campaign criteria. As shown in FIG. 6B, after receiving the campaign criteria from the user interface 655, the inventory management system 660 can present a list of broadcasters having available spots that meet the campaign criteria. For example, display box 665 presents a list of four broadcasters (e.g., radio stations) meeting campaign criteria (e.g., minimum spots of 10 and maximum spots of 40). Additionally, for each broadcaster on the list, display box 665 can display the category of broadcast content (e.g., news, pop, rock, or country), the market (e.g., San Diego, Austin, Boston, or D.C.), and the number of available spots.

Using information presented in the display box 665, process 600, at 615, determines whether the available spots are less than the total advertising spots needed to achieve the campaign objective. For example, suppose that the total number of spots needed for the advertising campaign is 100 spots. Process 600 can automatically determine that the available spots presented in display box 665 (which shows four broadcaster having a combined available spot of 85 spots) are not sufficient in achieving the total number needed (e.g., 100 spots) for the campaign. Thus, a larger list of broadcasters and available spots are needed. At 620, process 600 generates modified campaign criteria based on the determination of 615.

For example, suppose that the number of minimum and maximum spots to be allocated is modified from a minimum of 10 and a maximum of 40 to a minimum of 5 and a maximum of 40. As shown in FIG. 6B, based on this modified criteria, inventory management system 660 can present a new list of broadcasters with their corresponding available spots. For example, display box 670 presents six broadcasters (e.g., radio stations) and their corresponding category, market, and available spots. By modifying the number of specified minimum spots from 10 to 5, two stations were added to the list of broadcasters in display box 670.

Process 600, at 625, obtains newly available advertising spots from a new list of broadcasters that meet the modified campaign criteria. Process 600 then proceeds to 615, where the available advertising spots from the new list is compared with the total number of advertising spots required for the advertising campaign. Thus, process 600 can dynamically adjust the number of available advertising spots by repeating 615 through 625, until the available advertising spots are greater than or equal to the total number of advertising spots needed. At 630, process 630 proceeds to allocate advertising spots for the advertising campaign. Once the available advertising spots are allocated to the advertising campaign, a campaign reach and frequency can be calculated, as noted above, e.g., based on the allocated spots and third-party demographics data.

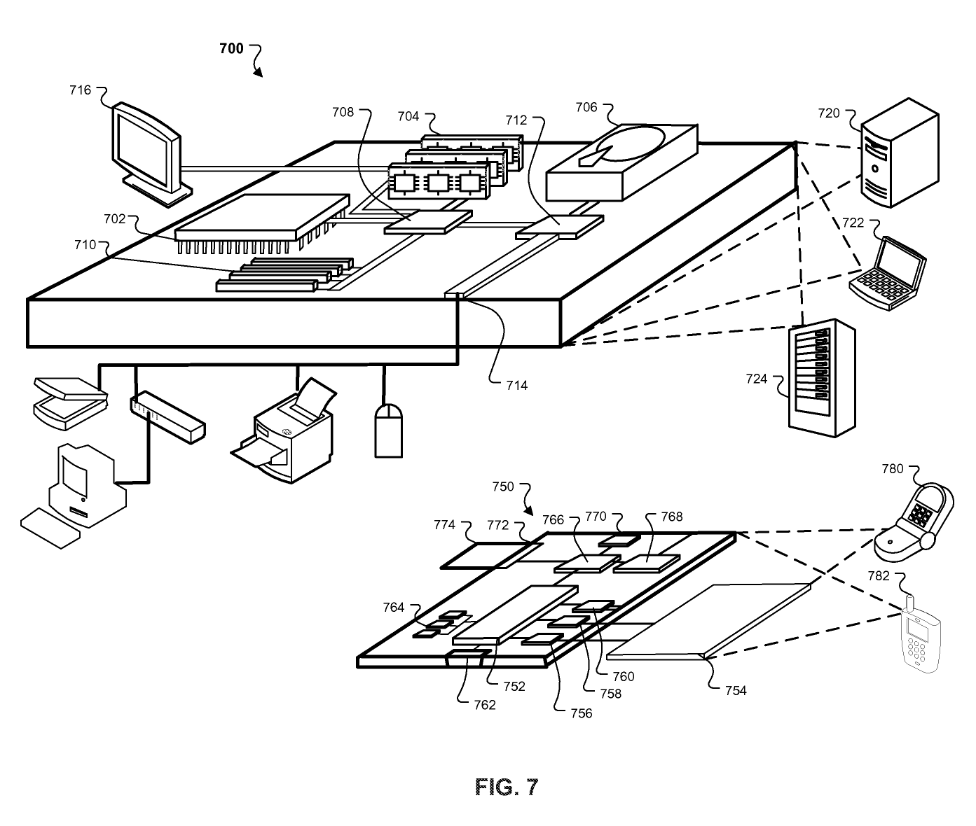

FIG. 7 is a block diagram of a computing device and system that can be used, e.g., to implement the advertising campaign booking system. Computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708.

In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system). The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Where appropriate, the systems and the functional operations described in this specification can be implemented in digital electronic circuitry, or in computer software, firmware, or hardware, including the structural means disclosed in this specification and structural equivalents thereof, or in combinations of them. The techniques can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform the described functions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the described embodiments. For example, although a specific implementation of using specified minimum and maximum number of advertising spots per broadcaster per week has been described, it is understood that other implementations can be based on broadcaster groups (e.g., a network of radio stations). Additionally, other implementations can be based on a specified time period of a month or a two-week period such that the appropriate amount of time for computing “frequency” can be used. Accordingly, other embodiments are within the scope of the following claims.

What is claimed is:

1. A computer-implemented method comprising:
receiving campaign criteria including target reach and frequency for an advertising campaign;
allocating advertising spots based on the campaign criteria;
generating projected campaign reach and frequency based, at least in part, on the allocated advertising spots;
determining whether projected campaign reach and frequency sufficiently match target reach and frequency; and
dynamically adjusting the allocation of advertising spots when the projected campaign reach and frequency do not sufficiently match the target reach and frequency.

2. The method of claim 1, wherein receiving campaign criteria further includes receiving a specified minimum and a specified maximum number of advertising spots to be allocated per broadcaster group within a predetermined time period.

3. The method of claim 1, further comprising obtaining available advertising spots from broadcasters that meet the campaign criteria.

4. The method of claim 1, further comprising:
booking the advertising campaign when the projected campaign reach and frequency sufficiently match the target reach and frequency.

5. The method of claim 2, wherein the broadcaster group comprises one or more broadcasters and the predetermined time period comprises a period of a week, two-weeks, or a month.

6. The method of claim 3, wherein dynamically adjusting the allocation of advertising spots comprises:
generating a new minimum and a new maximum number of advertising spots to be allocated; and
obtaining newly available advertising spots to fill the advertising campaign based on the new minimum and the new maximum number of advertising spots.

7. The method of claim 1, wherein allocating advertising spots comprises:
obtaining available advertising spots from broadcasters that meet the campaign criteria; and
sorting the broadcasters based on a predetermined campaign metric.

8. The method of claim 7, wherein the predetermined campaign metric comprises broadcaster efficiency or target cost per thousand impressions (CPM).

9. The method of claim 7, wherein allocating advertising spots further comprises:
determining whether a first broadcaster's available advertising spots are less than the specified minimum number of advertising spots;
determining whether the first broadcaster is a strategic broadcaster when the first broadcaster's available advertising spots are less than the specified minimum number of advertising spots; and
booking all the available advertising spots from the first broadcaster when the broadcaster is a strategic broadcaster.

10. The method of claim 9, wherein allocating advertising spots further comprises:
calculating a number of advertising spots needed from the first broadcaster when the first broadcaster's available advertising spots are not less than the specified minimum number of advertising spots.

11. The method of claim 10, wherein allocating advertising spots further comprises:
determining whether the number of advertising spots needed from the first broadcaster is greater than the specified maximum number of advertising spots.

12. The method of claim 11, wherein allocating advertising spots further comprises:
booking the number of advertising spots needed from the first broadcaster when the number of advertising spots needed from the first broadcaster is not greater than the specified maximum number of advertising spots; and
booking the specified maximum number of advertising spots from the first broadcaster when the number of advertising spots needed from the first broadcaster is greater than the specified maximum number of advertising spots.

13. The method of claim 3, wherein the broadcasters comprise terrestrial radio stations, satellite radio stations, television stations, podcasters, cellular broadcasters, or Internet broadcasters.

14. The method of claim 1, wherein the advertising campaign criteria are specified by an advertiser or a customer service representative via a user interface.

15. A computing device comprising a computer program product stored on a computer readable medium, the stored computer program product including executable instructions causing the computing device to perform functions comprising:
receiving campaign criteria including target reach and frequency for an advertising campaign;
allocating advertising spots based on the campaign criteria;
generating projected campaign reach and frequency based, at least in part, on the allocated advertising spots;
determining whether projected campaign reach and frequency sufficiently match target reach and frequency; and
dynamically adjusting the allocation of advertising spots when the projected campaign reach and frequency do not sufficiently match the target reach and frequency.

16. The stored computer program product of claim 15, wherein receiving campaign criteria further includes receiving a specified minimum and a specified maximum number of advertising spots to be allocated per broadcaster group within a predetermined time period.

17. The stored computer program product of claim 15, further including executable instructions causing the computing device to perform functions comprising:
obtaining available advertising spots from broadcasters that meet the campaign criteria.

18. The stored computer program product of claim 15, further including executable instructions causing the computing device to perform functions comprising:
booking the advertising campaign when the projected campaign reach and frequency match the target reach and frequency.

19. The stored computer program product of claim 16, wherein the broadcaster group comprises one or more broadcasters and the predetermined time period comprises a period of a week, two-weeks, or a month.

20. The stored computer program product of claim 18, wherein dynamically adjusting the allocation of advertising spots comprises:
generating a new minimum and a new maximum number of advertising spots to be allocated; and
obtaining newly available advertising spots to fill the advertising campaign based on the new minimum and the new maximum number of advertising spots.

21. The stored computer program product of claim 15, wherein allocating advertising spots comprises:
obtaining available advertising spots from broadcasters that meet the campaign criteria; and
sorting the broadcasters based on a predetermined campaign metric.

22. The stored computer program product of claim 21, wherein the predetermined campaign metric comprises efficiency or target cost per thousand impressions (CPM).

23. A system comprising:
an advertiser-facing module configured to interface with an advertiser and to obtain campaign criteria comprising target reach and frequency for an advertising campaign;
a metrics calculation module configured to calculate projected campaign reach and frequency;
means for dynamically allocating advertising spots in the advertising campaign to cause the calculated reach and frequency to better match the target reach and frequency; and
a broadcaster-facing module configured to interface with one or more broadcasters that broadcast one or more advertisements during the allocated advertising spots.
